(19) United States
(12) Patent Application Publication
(10) Pub. No.: US 2009/0152491 A1
(43) Pub. Date: Jun. 18, 2009

(54) Thermally conductive resin compositions

(75) Inventor: Yuji Saga, Tochigi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/291,590

(22) Filed: Nov. 12, 2008

Related U.S. Application Data
(60) Provisional application No. 61/003,430, filed on Nov. 16, 2007.

(51) Int. Cl. C09K 5/00; H02K 15/12

(52) U.S. Cl. 252/74; 252/73; 252/79; 310/45

(57) ABSTRACT

Thermally conductive polymer resin compositions comprising polymer, spherical or granular shape thermally conductive filler, and platy thermally conductive filler, and optionally a polymeric toughening agent. The compositions are particularly useful for metal/polymer hybrid parts.

### CROSS REFERENCE TO RELATED APPLICATIONS

This application claims the benefit of U.S. Provisional Application No. 61/003,430, filed Nov. 16, 2007, which is incorporated herein by reference in its entirety.

### FIELD OF THE INVENTION

Thermally conductive plastic resin compositions comprising polymer and combination of spherical or granular shape thermally conductive fillers with platy shaped thermally conductive fillers are useful as encapsulant compositions.

### BACKGROUND OF THE INVENTION

Because of their excellent mechanical and electrical insulation properties, polymeric resin compositions are used in a broad range of applications such as in automotive parts, electrical and electronic parts, machine parts and the like. In many cases, because of the design flexibility they permit, sealing capability and their electrical insulation properties, polymer resin compositions can be used as encapsulants for electrical and electronics devices or motors. However, not only are electrical insulation properties needed in the encapsulating polymer compositions, but they also often need to have higher thermal conductivities especially with the downsizing trend of some electrical devices. Another important requirement for encapsulating polymer compositions is that their Coefficients of Linear Thermal Expansions (CLTEs) should be close to CLTEs of materials encapsulated with the polymer compositions to retain seal integrity while releasing heat generated by the encapsulated devices. In general, higher loading with thermally conductive filler in polymer leads to higher thermal conductivity and lower CLTE because the fillers' CLTEs are often lower than polymers' CLTEs. However, high filler loadings often decreases flow-ability of polymer compositions in melt forming processes, and that can lead to failure of sealing performance or damage of core devices encapsulated with the polymer compositions. Thus, a thermally conductive, electrically insulating, low CLTE polymer composition with good flowability is desired.

Japanese patent application publication 2003-040619 discloses a method of surface treating calcium fluoride powder with a silane coupling agent and blending the coated powder with thermoplastic resins and, optionally, fillers to produce a thermally conductive composition. However, there is no mention of a way to achieve both thermal conductivity and low CLTE without significant increase of viscosity of the polymer compositions.

WO 2005071001 discloses a polymer composition comprising thermoplastic polymer and calcium fluoride and fibrous filler. However use of fibrous filler leads to anisotropy in mold shrinkage and in thermal conductivity between flow direction and transverse direction due to orientation of the fibrous filler.

### SUMMARY OF THE INVENTION

A thermally conductive polymer composition, comprising:
(a) 25 to 75 volume percent of one or more polymers;
(b) 7 to about 65 volume percent of electrically insulative and spherical or granular shape thermally conductive;
(c) 2 to 50 volume percent of electrically insulative platy thermally conductive fillers; and

the volume ratio of (c) to (b) is between 10 to 90 and 70 to 30, and the above stated percentages are based on the total volume of the composition.

### DETAILED DESCRIPTION OF THE INVENTION

The composition of the present invention comprises (a) at least one polymer, (b) at least spherical or granular shape thermally conductive filler, (c) at least one platy shape thermally conductive filler, and optionally (d) at least one polymeric toughening agent.

(a) The polymer is the polymer matrix of the composition, in other words the one or more polymers are the continuous phase. Useful thermoplastic polymers include polycarbonates, polyolefins such as polyethylene and polypropylene, polyacetals, acrylics, vinyls, fluoropolymers, polyamides, polyesters, polysulfones, polyphenylene sulfides, liquid crystal polymers such as aromatic polyesters, polyetherimides, polyamideimides, polyacetals, polyphenylene oxides, polyarylates, polyetheretherketones (PEEK), polyetherketoneketones (PEKK), and syndiotactic polystyrenes, and blends thereof.

Alternatively, thermosetting polymers such as epoxies, polyimides, silicones, unsaturated polyester and polyurethanes can be used as component (a).

Preferred are thermoplastic polymers and polyesters, polyamides, and liquid crystal polymers are especially preferred.

More preferred thermoplastic polyesters include polyesters, and more preferably are, in general, linear saturated condensation products of diols and dicarboxylic acids, or reactive derivatives thereof. Preferably, they will comprise condensation products of aromatic dicarboxylic acids having 8 to 14 carbon atoms and at least one diol selected from the group consisting of neopentyl glycol, cyclohexanedimethanol, 2,2-dimethyl-1,3-propane diol and aliphatic glycols of the formula HO(CH₂)ₙOH where n is an integer of 2 to 10. Up to 20 mole percent of the diol may be an aromatic diol such as ethoxylated bisphenol A, sold under the tradename Dianol® 220 by Akzo Nobel Chemicals, Inc.; hydroquinone; biphenol; or bisphenol A. Up to 50 mole percent of the aromatic dicarboxylic acids can be replaced by at least one different aromatic dicarboxylic acid having from 8 to 14 carbon atoms, and/or up to 20 mole percent can be replaced by an aliphatic dicarboxylic acid having from 2 to 12 carbon atoms. Copolymers may be prepared from two or more diols or reactive equivalents thereof and at least one dicarboxylic acid or reactive equivalent thereof or two or more dicarboxylic acids or reactive equivalents thereof and at least one diol or reactive equivalent thereof. Difunctional hydroxy acid monomers such as hydroxybenzoic acid or hydroxynaphthoic acid or their reactive equivalents may also be used as comonomers.

Preferred polyesters include poly(ethylene terephthalate) (PET), poly(1,4-butylene terephthalate) (PBT), poly(1,3-propylene terephthalate) (PPT), poly(1,4-butylene 2,6-naphthalate) (PBN), poly(ethylene 2,6-naphthalate) (PEN), poly(1,4-cyclohexylene dimethylene terephthalate) (PCT), and copolymers and mixtures of the foregoing. Also preferred are 1,4-cyclohexylene dimethylene terephthalate/isophthalate copolymer and other linear homopolymer esters derived from aromatic dicarboxylic acids, including isophthalic acid; bibenzoic acid; naphthalenedicarboxylic acids including the 1,5-; 2,6-; and 2,7-naphthalenedicarboxylic acids; 4,4′-diphenylenedicarboxylic acid;

bis(p-carboxyphenyl) methane; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid, and glycols selected from the group consisting of 2,2-dimethyl-1,3-propane diol; neopentyl glycol; cyclohexane dimethanol; and aliphatic glycols of the general formula HO(CH₂)ₙOH where n is an integer from 2 to 10, e.g., ethylene glycol; 1,3-trimethylene glycol; 1,4-tetramethylene glycol; -1,6-hexamethylene glycol; 1,8-octamethylene glycol; 1,10-decamethylene glycol; 1,3-propylene glycol; and 1,4-butylene glycol. Up to 20 mole percent, as indicated above, of one or more aliphatic acids, including adipic, sebacic, azelaic, dodecanedioic acid or 1,4-cyclohexanedicarboxylic acid can be present. Also preferred are copolymers derived from 1,4-butanediol, ethoxylated bisphenol A, and terephthalic acid or reactive equivalents thereof. Also preferred are random copolymers of at least two of PET, PBT, and PPT, and mixtures of at least two of PET, PBT, and PPT, and mixtures of any of the forgoing.

The thermoplastic polyester may also be in the form of copolymers that contain poly(alkylene oxide) soft segments (blocks). The poly(alkylene oxide) segments are present in about 1 to about 15 parts by weight per 100 parts per weight of thermoplastic polyester. The poly(alkylene oxide) segments have a number average molecular weight in the range of about 200 to about 3,250 or, preferably, in the range of about 600 to about 1,500. Preferred copolymers contain poly(ethylene oxide) or poly(tetramethylene glycol) blocks incorporated into a PET or PBT chain, as to form a thermoplastic poly(ether-ester). Methods of incorporation are known to those skilled in the art and can include using the poly(alkylene oxide) soft segment as a comonomer during the polymerization reaction to form the polyester. PET may be blended with copolymers of PBT and at least one poly(alkylene oxide). A poly(alkylene oxide) may also be copolymerized in a PET/PBT copolymer. The inclusion of a poly(alkylene oxide) soft segment into the polyester portion of the composition may accelerate the rate of crystallization of the polyester.

Polyamides are another preferred type of polymer. Preferred polyamides include polyamide 6, polyamide 66, polyamide 612, polyamide 610, or other aliphatic polyamides and semi-aromatic polyamides, such as those derived from terephthalic acid and/or isophthalic acid. Examples include polyamides 9T; 10T; 12T; polyamides derived from hexamethylenediamine, adipic acid, and terephthalic acid; and polyamides derived from hexamethylenediamine, 2-methylpentamethylenediamine, and terephthalic acid. Blends of two or more polyamides may be used.

Polyacetals are another preferred type of polymer. Polyacetals can be either one or more homopolymers, copolymers, or a mixture thereof. Homopolymers are prepared by polymerizing formaldehyde or formaldehyde equivalents, such as cyclic oligomers of formaldehyde. Copolymers can contain one or more comonomers generally used in preparing polyoxymethylene compositions. Commonly used comonomers include alkylene oxides of 2-12 carbon atoms. If a copolymer is selected, the quantity of comonomer will not be more than 20 weight percent, preferably not more than 15 weight percent, and most preferably about two weight percent. Preferable comonomers are ethylene oxide and butylene oxide, and preferable polyoxymethylene copolymers are copolymers of formaldehyde and ethylene oxide or butylene oxide where the quantity of ethylene oxide or butylene oxide is about two (2) weight percent. It is also preferred that the homo- and copolymers are: 1) those whose terminal hydroxy groups are end-capped by a chemical reaction to form ester or ether groups; or, 2) copolymers that are not completely end-capped, but that have some free hydroxy ends from the comonomer unit. Preferred end groups, in either case, are acetate and methoxy.

Liquid crystalline polymers (LCP) are another preferred type of polymer. By a LCP is meant a polymer that is anisotropic when tested using the TOT test or any reasonable variation thereof, as described in U.S. Pat. No. 4,118,372, which is hereby included by reference. Useful LCPs include polyesters, poly(ester-amides), and poly(ester-imides). One preferred form of LCP is “all aromatic”, that is all of the groups in the polymer main chain are aromatic (except for the linking groups such as ester groups), but side groups which are not aromatic may be present.

The polymer (a) will preferably be present in about 25 to about 75 volume percent, or more preferably about 30 to about 60 volume percent, based on the total volume of the composition.

The thermally conductive fillers used as component (b) in the present invention are electrically insulative, and their shapes are spherical or granular shape. By electrically insulative is meant the volume resistivity of both types of thermally conductive filler are higher than 10⁹ ohm·cm, preferably higher than 10¹² ohm·cm. Volume resistivity of the fillers is measured according to ASTM D257.

“Spherical” or “granular” means that the aspect ratio of the filler (b) is low. Average aspect ratio of the filler (b) is less than 5, or preferably less than 3. The thermal conductivity of the spherical or granular filler is 5 W/m° K or more, preferably 10 W/m° K or more, more preferably 20 W/m° K or more, and very preferably 50 W/m° K. or more. The thermal conductivity of the platy filler is 5 W/m° K, preferably 10 W/m° K, more preferably 20 W/m° K and very preferably 50 W/m° K.

Examples include ceramic powders, including aluminum oxide, magnesium oxide, spherically agglomerated boron nitride, aluminum nitride, silicon nitride, calcium fluoride, zinc oxide.

The filler particles or granules can have a broad particle size distribution. Preferably, maximum particle size is less than 300 microns, and more preferably, less than 200 microns. Preferably the average particle size is 5 μm to 100 μm, more preferably 15 μm to 60 μm.

Surface of the thermally-conductive fillers as component (b) can be modified with other material to improve properties of the compositions. For example, a coupling agent such as aminosilanes and epoxysilanes to improve mechanical strength and flow-ability of the compositions, and a coating agent such as silicon to improve water resistance of the fillers.

Preferably, component (b) are thermally conductive fillers whose Mohs hardness is less than 7, and more preferably less than 5. If a filler whose Mohs hardness is not less than 7 is used, screws, mold surface and objects encapsulated with the compositions is damaged in injection molding process. Preferred examples are magnesium oxide and calcium fluoride. More preferred is calcium fluoride.

The component (b) will preferably be present in 7 to 65 volume percent, or more preferably 25 to 55 volume percent, based on the total volume of the composition.

The thermally conductive fillers used as component (c) in the present invention are platy and electrically insulative. The average aspect ratio of the platy filler (c) is greater than 5, preferably greater than about 10. Examples include boron nitride, and graphite coated with electrically insulative materials. Surface of the thermally-conductive fillers as component (c) can be modified with other material to improve properties of the compositions. For example, a coupling agent such as aminosilanes and epoxysilanes to improve mechanical strength of the compositions, and a coating agent such as silicon to improve water resistance of the fillers. A preferred filler (c) is boron nitride. The component (c) will preferably be present in 2 to 50 volume percent, or more preferably 5 to 25 volume percent, based on the total volume of the composition.

The volume ratio of (c)/(b) is between 10/90 and 70/30, or preferably between 15/85 and 50/50.

The polymeric toughening agent optionally used as component (d) in the present invention is any toughening agent that is effective for the polymer used. When the thermoplastic polymer is a polyester, the toughening agent will typically be an elastomer or has a relatively low melting point, generally <200° C., preferably <150° C. and that has attached to it functional groups that can react with the thermoplastic polyester (and optionally other polymers present). Since thermoplastic polyesters usually have carboxyl and hydroxyl groups present, these functional groups usually can react with carboxyl and/or hydroxyl groups. Examples of such functional groups include epoxy, carboxylic anhydride, hydroxyl (alcohol), carboxyl, and isocyanate. Preferred functional groups are epoxy, and carboxylic anhydride, and epoxy is especially preferred. Such functional groups are usually “attached” to the polymeric toughening agent by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl (meth)acrylate, glycidyl (meth)acrylate, and 2-isocyanatoethyl (meth)acrylate. In addition to ethylene and a functional (meth)acrylate monomer, other monomers may be copolymerized into such a polymer, such as vinyl acetate, unfunctionalized (meth)acrylate esters such as ethyl (meth)acrylate, n-butyl (meth)acrylate, and cyclohexyl (meth)acrylate. Preferred toughening agents include those listed in U.S. Pat. No. 4,753,980, which is hereby included by reference. Especially preferred toughening agents are copolymers of ethylene, ethyl acrylate or n-butyl acrylate, and glycidyl methacrylate.

It is preferred that the polymeric toughening agent used with thermoplastic polyesters contain about 0.5 to about 20 weight percent of monomers containing functional groups, preferably about 1.0 to about 15 weight percent, more preferably about 7 to about 13 weight percent of monomers containing functional groups. There may be more than one type of functional monomer present in the polymeric toughening agent. It has been found that toughness of the composition is increased by increasing the amount of polymeric toughening agent and/or the amount of functional groups. However, these amounts should preferably not be increased to the point that the composition may crosslink, especially before the final part shape is attained.

The polymeric toughening agent used with thermoplastic polyesters may also be thermoplastic acrylic polymers that are not copolymers of ethylene. The thermoplastic acrylic polymers are made by polymerizing acrylic acid, acrylate esters (such as methyl acrylate, n-propyl acrylate, isopropyl acrylate, n-butyl acrylate, n-hexyl acrylate, and n-octyl acrylate), methacrylic acid, and methacrylate esters (such as methyl methacrylate, n-propyl methacrylate, isopropyl methacrylate, n-butyl methacrylate (BA), isobutyl methacrylate, n-amyl methacrylate, n-octyl methacrylate, glycidyl methacrylate (GMA) and the like). Copolymers derived from two or more of the forgoing types of monomers may also be used, as well as copolymers made by polymerizing one or more of the forgoing types of monomers with styrene, acrylonitrile, butadiene, isoprene, and the like. Part or all of the components in these copolymers should preferably have a glass transition temperature of not higher than 0° C. Preferred monomers for the preparation of a thermoplastic acrylic polymer toughening agent are methyl acrylate, n-propyl acrylate, isopropyl acrylate, n-butyl acrylate, n-hexyl acrylate, and n-octyl acrylate.

It is preferred that a thermoplastic acrylic polymer toughening agent have a core-shell structure. The core-shell structure is one in which the core portion preferably has a glass transition temperature of 0° C. or less, while the shell portion is preferably has a glass transition temperature higher than that of the core portion. The core portion may be grafted with silicone. The shell section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition.

Suitable toughening agents for polyamides are described in U.S. Pat. No. 4,174,358. Preferred toughening agents include polyolefins modified with a compatibilizing agent such as an acid anhydride, dicarboxylic acid or derivative thereof, carboxylic acid or derivative thereof, and/or an epoxy group. The compatibilizing agent may be introduced by grafting an unsaturated acid anhydride, dicarboxylic acid or derivative thereof, carboxylic acid or derivative thereof, and/or an epoxy group to a polyolefin. The compatibilizing agent may also be introduced while the polyolefin is being made by copolymerizing with monomers containing an unsaturated acid anhydride, dicarboxylic acid or derivative thereof, carboxylic acid or derivative thereof, and/or an epoxy group. The compatibilizing agent preferably contains from 3 to 20 carbon atoms. Examples of typical compounds that may be grafted to (or used as comonomers to make) a polyolefin are acrylic acid, methacrylic acid, maleic acid, fumaric acid, itaconic acid, crotonic acid, citraconic acid, maleic anhydride, itaconic anhydride, crotonic anhydride and citraconic anhydride.

Preferred toughening agents for polyacetals include thermoplastic polyurethanes, polyester polyether elastomers, other functionalized and/or grafted rubber, and polyolefins that contain polar groups that are either grafted to their backbones or were incorporated by copolymerizing with a monomer that contained one or more polar groups. Preferable comonomers are those that contain epoxide groups, such as glycidyl methacrylate. A preferred toughening agent is EBAGMA (a terpolymer derived from ethylene, butyl acrylate, and glycidyl methacrylate).

When used, the optional polymeric toughening agent will preferably be present in about 0.5 to about 25 volume percent, or more preferably in about 2 to about 20 volume percent, based on the total weight of the composition.

The compositions of this invention may optionally include one or more plasticizers, nucleating agents, flame retardants, flame retardant synergists, heat stabilizers, antioxidants, dyes, pigments, mold release agents, lubricants, UV stabilizers, (paint) adhesion promoters, and the like which are sometimes conventionally part of such polymer compositions.

The compositions of the present invention are preferably in the form of a melt-mixed or a solution-mixed blend, more preferably melt-mixed, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method or by mixing components other than matrix polymer with monomers of the polymer matrix and then polymerizing the monomers. The component materials may be mixed to homogeneity using a melt-mixer such as a single or twin-screw extruder, blender, kneader, Banbury mixer, etc. to give a resin composition. Part of the materials may be mixed in a melt-mixer, and the rest of the materials may then be added and further melt-mixed until homogeneous. The sequence of mixing in the manufacture of the thermally conductive polymer resin composition of this invention may be such that individual components may be melted in one shot, or the filler and/or other components may be fed from a side feeder, and the like, as will be understood by those skilled in the art.

The composition of the present invention may be formed into articles using methods known to those skilled in the art, such as, for example, injection molding, blow molding, extrusion, press molding or transfer molding. Such articles can include those for use in motor housings, lamp housings, lamp housings in automobiles and other vehicles, electrical and electronic housings, insulation bobbin which exist between coiled wire and magnetic inducible metal core in stator of motors or generators, and housings which substantially encapsulates the stator core of motors or generators. Examples of lamp housings in automobiles and other vehicles are front and rear lights, including headlights, tail lights, and brake lights, particularly those that use light-emitting diode (LED) lamps. The articles may serve as replacements for articles made from aluminum or other metals in many applications.

### EXAMPLES

### Compounding and Molding Method

The polymeric compositions shown in Table 1 were prepared by compounding in a 32 mm Werner and Pfleiderer twin screw extruder. All ingredients were blended together and added to the rear of the extruder except that fibers were side-fed into a downstream barrel. Barrel temperatures were set at about 320° C. for HTN (high temperature nylon) compositions and about 330° C. for LCP compositions, respectively.

The compositions were molded into ISO test specimens and on an injection molding machine for the measurement of CLTE and thermal conductivity. And, the compositions were molded into 0.8 mm thickness dumbbell shape bars which have weld line in the center portion by injecting the resins from each end for the measurement of tensile weld elongation. Melt temperature were about 325° C. and mold temperatures were about 140° C. for the compositions.

### Testing Methods

CLTE in mold flow direction (MD) and transverse direction (TD) were determined on about center portion of the ISO bar in the temperature range from −40 to 180 degree C. using ASTM D696 method.
Thermal conductivity was determined on gate side area of the ISO bar with a thickness of 4 mm using Laser Flash Method as described in ASTM E1461. Results are shown in Table 1.
The following terms are used in Table 1:
HTN-1 refers to Zytel® HTN501, a polyamide 6T/DT (a copolymer of terephthalic acid and 1,6-hexanediamine and 2-methyl-1,5-pentanediamine) manufactured by E.I. du Pont de Nemours and Co., Wilmington, Del., USA.,
PA66 refers to Zytel® 101, a polyamide66 manufactured by E.I. du Pont de Nemours and Co., Wilmington, Del., USA.
Modified-EPDM refers to EPDM (ethylene/propylene/diene polyolefin) grafted with maleic anhydride.
CaF₂ refers to Calcium fluoride powder with an average size 30 μm manufactured by Sankyo Seifun Co., Ltd., and an aspect ratio of 1.8. CaF₂ has a reported thermal conductivity of 10 W/m° K.
m-MqO refers to magnesium oxide powder made by surface modification with 1% of an amino-silane coupling agent on Coolfiller® CF₂-100A manufactured by Tateho Chemical Industries Co., Ltd., and has an average aspect ratio of 1.7. An average size of the Coolfiller is about 25 μm. MgO's reported thermal conductivity is 40 W/m° K.
BN refers to Denka boron nitride GP with an average size of 8 μm and no sizing available from Nyco Minerals, Calgary, Alberta, Canada. It has an average aspect ratio of 13. Its thermal conductivity is reported to be >200 W/m° K.

TABLE 1

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| HTN-1 | 33 | 33 | 33 | 33 | 33 | 33 |
| PA66 | 14 | 14 | 14 | 14 | 14 | 14 |
| Modified- | 3 | 3 | 3 | 3 | 3 | 3 |
| EPDM | | | | | | |
| CaF₂ | 20 | 40 | — | — | — | 50 |
| m-MgO | — | — | 40 | — | 50 | — |
| BN | 30 | 10 | 10 | 50 | — | — |
| Thermal conductivity | 1.3 | 1.3 | 1.6 | 1.0 | 1.5 | 1.3 |
| (W/moK) | | | | | | |
| CLTE in MD | 29 | 38 | 41 | 11 | 43 | 50 |
| (ppm) | | | | | | |
| CLTE in TD | 26 | 41 | 42 | 8 | 44 | 52 |
| (ppm) | | | | | | |
| CLTE in MD/ | 1.12 | 0.93 | 0.98 | 1.38 | 0.98 | 0.96 |
| CLTE in TD | | | | | | |

All ingredient quantities are given in volume percent relative to the total volume of the composition.

What is claimed is:

1. A thermally conductive polymer composition, comprising:
(a) about 25 to about 75 volume percent of polymer;
(b) about 7 to about 65 volume percent of electrically insulative and spherical or granular shaped thermally conductive filler;
(c) about 2 to about 50 volume percent of electrically insulative platy thermally conductive fillers;
and wherein the volume ratio of (c) to (b) is between 10 to 90 and 70 to 30.
the above stated percentages being based on the total volume of the composition.

2. The composition of claim 1 wherein the polymer is thermoplastic polymer.

3. The composition of claim 2 wherein the polymer is at least one selected from the group consisting of thermoplastic polyester, thermoplastic polyamide and liquid crystalline polymer.

4. The composition of claim 1 wherein Mohs hardness of the filler (b) is less than 7.

5. The composition of claim 1 wherein the filler (b) is at least one selected from calcium fluoride, and magnesium oxide whose surface is modified to improve water resistance.

6. The composition of claim 1 wherein the filler (b) is calcium fluoride.

7. The composition of claim 1 wherein the platy filler (c) is at least one selected from the group consisting of, boron nitride, and graphite whose surface is coated with an electrically insulative compound.

8. An article made from the composition of claim 1.

9. A metal/polymer hybrid article made with the composition of claim 1.

10. An insulator of a stator core of motors or generators made of the composition of claim 1.

11. A stator assembly encapsulated with the composition of claim 10.

12. The composition of claim 1 additionally comprising about 0.01 to about 15 volume percent of at least one polymeric toughening agent.

13. The composition of claim 12 wherein the polymer is thermoplastic polymer.

14. The composition of claim 12 wherein the polymer is at least one selected from the group consisting of thermoplastic polyester, thermoplastic polyamide and liquid crystalline polymer.

15. The composition of claim 12 wherein the polymeric toughening agent is present in about 2 to about 20 volume percent, based on the total weight of the composition.

16. The composition of claim 12 wherein Mohs hardness of the filler (b) is less than 7.

17. The composition of claim 12 wherein the filler (b) is at least one selected from calcium fluoride or magnesium oxide, each of whose surface's is modified to improve water resistance.

18. The composition of claim 12 wherein the filler (b) is calcium fluoride.

19. The composition of claim 12 wherein the platy filler (c) is at least one selected from the group consisting of boron nitride and graphite whose surface is coated with an electrically insulative compound.

20. An article made from the composition of claim 12.

21. A metal/polymer hybrid article made with the composition of claim 12.

22. An insulator of a stator core of motors or generators made of the composition of claim 12.

23. A stator assembly encapsulated with the composition of claim 1.
